(19) United States
(12) Patent Application Publication
(10) Pub. No.: US 2024/0351117 A1
(43) Pub. Date: Oct. 24, 2024

(54) DRILL GUIDE BUSHING ASSEMBLY

(71) Applicant: Spirit AeroSystems, Inc., Wichita, KS (US)

(72) Inventors: Barry Nunnery, Wichita, KS (US); Chelsea Sewell, Wichita, KS (US); Kaelan Roberts, Wichita, KS (US); John Price, Wichita, KS (US)

(21) Appl. No.: 18/137,045

(22) Filed: Apr. 20, 2023

(51) Int. Cl. B23B 49/02

(52) U.S. Cl. CPC B23B 49/023

(57) ABSTRACT

A drill guide bushing assembly for use with a drill and a bit to drill a hole in an object comprises a bushing holder and a drill guide bushing. The bushing holder includes at least one upper wall, at least one lower wall, and a body connected to the at least one upper wall and the at least one lower wall. The body includes a bushing channel oriented along the axis thereof and having a hollow cylindrical shape. The drill guide bushing includes a central passage configured to receive the bit. The drill guide bushing is positioned within the bushing channel and configured to move axially therein. The drill guide bushing is coupled to the body of the bushing holder such that the drill guide bushing does not rotate within the bushing channel when the hole is being drilled.

### BACKGROUND OF THE INVENTION

A drill guide bushing provides assistance in drilling a straight-line hole in an object. The drill guide bushing includes a hollow cylindrical body with a central passage in which a bit of the drill is positioned and moves axially during the drilling process.

### SUMMARY OF THE INVENTION

Embodiments of the current invention provide a distinct advance in the art of drill guide bushings for use with a drill and a bit to drill a hole in an object. Specifically, the current invention provides a drill guide bushing assembly broadly comprising a bushing holder and a drill guide bushing. The bushing holder includes at least one upper wall, at least one lower wall, and a body connected to the at least one upper wall and the at least one lower wall. The body includes a bushing channel oriented along the axis thereof and having a hollow cylindrical shape. The drill guide bushing includes a central passage configured to receive the bit. The drill guide bushing is positioned within the bushing channel and configured to move axially therein. The drill guide bushing is coupled to the body of the bushing holder such that the drill guide bushing does not rotate within the bushing channel when the hole is being drilled.

Another embodiment of the drill guide bushing assembly broadly comprises a bushing holder, a drill guide bushing, and a pin. The bushing holder includes at least one upper wall, at least one lower wall, and a body connected to the at least one upper wall and the at least one lower wall. The body includes a bushing channel oriented along the axis thereof and having a hollow cylindrical shape. The drill guide bushing includes a disc having a cutout along a circumference thereof and a central passage configured to receive the bit. The drill guide bushing is positioned within the bushing channel and configured to move axially therein. The pin is connected to the body of the bushing holder and is positioned in the cutout such that the drill guide bushing is prevented from rotating within the bushing channel.

Yet another embodiment of the drill guide bushing assembly broadly comprises a method for using a drill guide bushing assembly with a drill and a bit to drill a first hole in a first object using a second hole in a second object for assistance. The method comprises the following: inserting a drill guide bushing of the drill guide bushing assembly into the second hole, wherein the second object is positioned on the first object; pressing a bushing holder, which holds the drill guide bushing, so that a lower edge of the bushing holder contacts a surface of the second object; and drilling the first hole in the first object with a drill bit that is positioned in a central passage of the drill guide bushing.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is an upper isometric view of a drill guide bushing assembly, constructed in accordance with various embodiments of the current invention, the drill guide bushing assembly comprising a drill guide bushing, a bushing holder, a pin, and a retaining ring;

FIG. 2 is a lower isometric view of the drill guide bushing assembly illustrating the drill guide bushing including a disc with a cutout in which the pin is positioned;

FIG. 3 is a perspective exploded view of the drill guide bushing assembly;

FIG. 4 is a top plan view of the drill guide bushing assembly;

FIG. 5 is a side cross-sectional view of the drill guide bushing assembly cut along the line 5-5 of FIG. 4;

FIG. 6 is an upper perspective view of a first object in which holes are to be drilled and a second object that already includes holes to be used as a template;

FIG. 7 is a side cross-sectional view of the drill guide bushing assembly with the drill guide bushing positioned in one of the holes of the second object;

FIG. 8 is a side cross-sectional view of the drill guide bushing assembly with a bit positioned in the drill guide bushing, in preparation to drill a hole in the first object;

FIG. 9 a side cross-sectional view of the drill guide bushing assembly with the bit positioned in the drill guide bushing, in the process of drilling the hole in the first object; and

FIG. 10 is a listing of at least a portion of the steps of a method for using a drill guide bushing assembly with a drill and a bit to drill a first hole in a first object using a second hole in a second object for assistance.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Relational and/or directional terms, such as “above”, “below”, “up”, “upper”, “upward”, “down”, “downward”, “lower”, “top”, “bottom”, “outer”, “inner”, etc., along with orientation terms, such as “horizontal” and “vertical”, may be used throughout this description. These terms retain their commonly accepted definitions and are used with reference to embodiments of the technology and the positions, directions, and orientations thereof shown in the accompanying figures. However, embodiments of the technology may be positioned and oriented in other ways or move in other directions. Therefore, the terms do not limit the scope of the current technology.

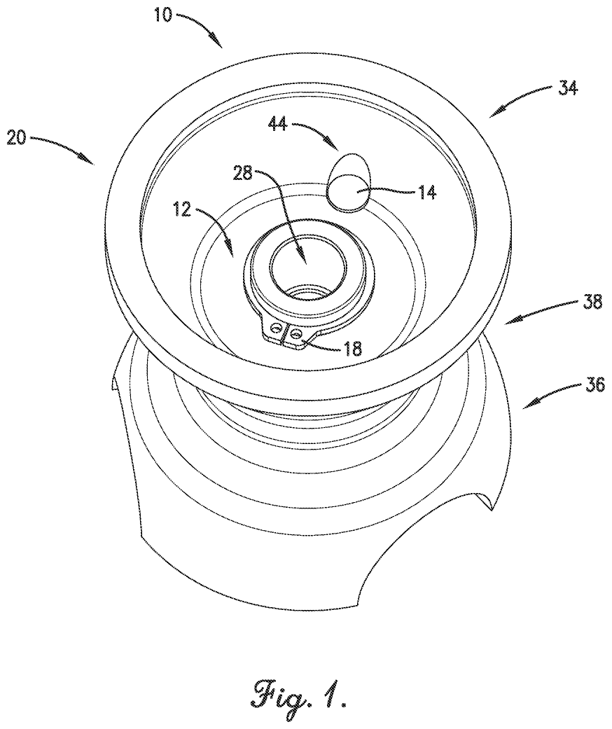

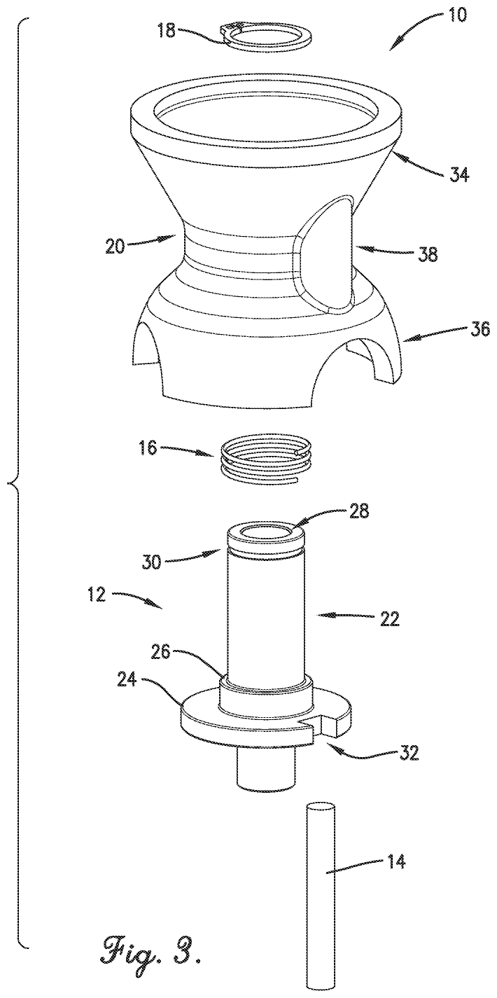

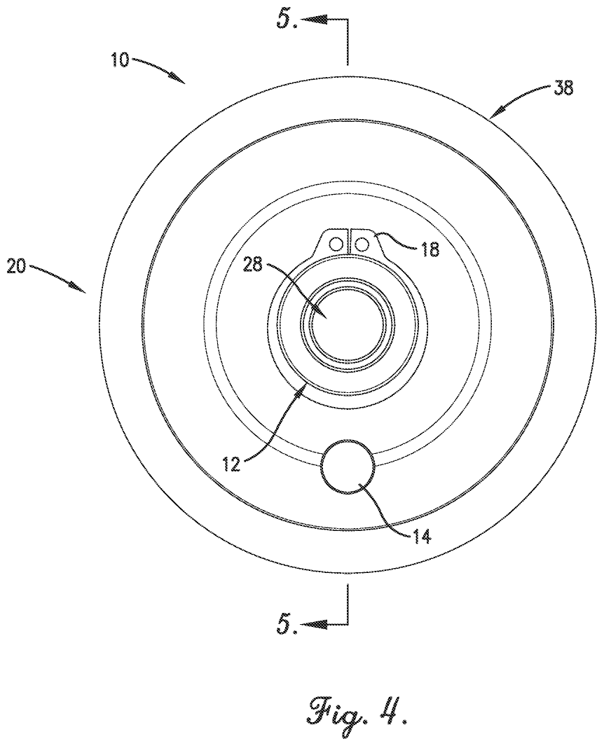

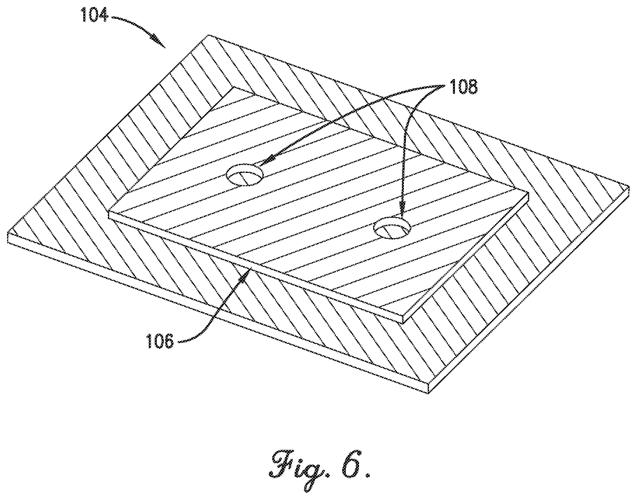

A drill guide bushing assembly 10, constructed in accordance with various embodiments of the current invention, is shown in FIGS. 1-5 and 6-9. The drill guide bushing assembly 10 broadly comprises a drill guide bushing 12, a pin 14, a spring 16, a retaining ring 18, and a bushing holder 20. The drill guide bushing assembly 10 receives a bit 100 of a drill 102 and provides guidance for the bit 100 to drill a surface normal hole. While the drill guide bushing assembly 10 may be used to assist drilling a hole, or a series of holes, in a single object, the drill guide bushing assembly 10 may also be used to assist drilling a series of holes 110 in a first object 104 while using a second object 106, that already has a series of holes 108, as a guide or template, as shown in FIG. 6. The second object 106 may be an already fabricated part with holes 108 already drilled in the proper locations, whereas the first object 104 may be fabricated but is waiting to be finished with holes 110. The second object 106 is overlaid onto the first object 104 in the proper orientation. As described in more detail below, the drill guide bushing assembly 10 is positioned on each of the holes 108 in turn, with the drill guide bushing 12 being placed in the hole 108. The hole 110 is drilled in the first object 104. Using the drill guide bushing assembly 10 as configured typically provides a smaller diameter hole 110 in the first object 104 than is required. But, the hole 110 is in the proper location and is surface normal. If preferred, the hole 110 is later enlarged to the proper sized diameter using a larger drill bit 100.

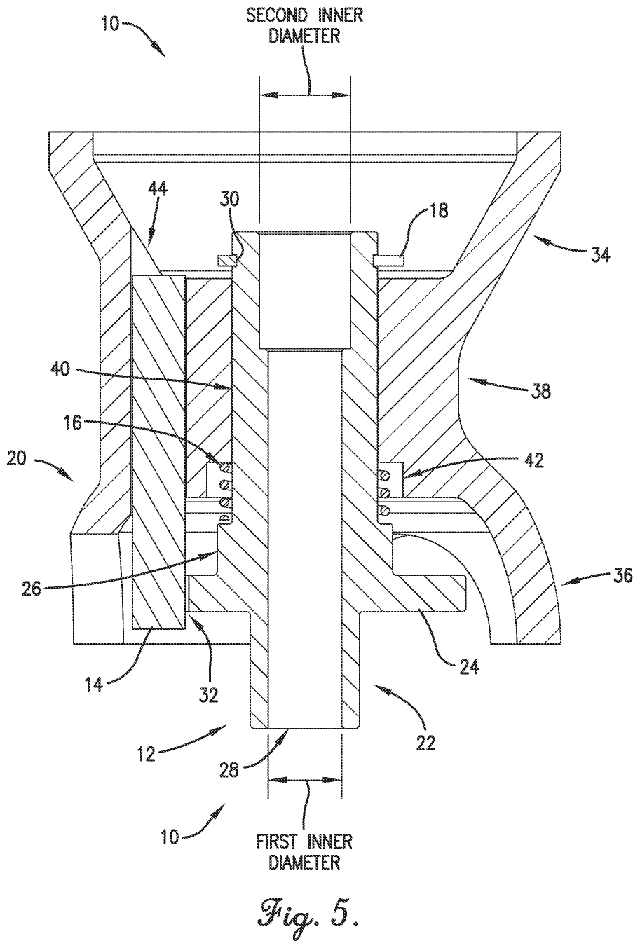

The drill guide bushing 12 has a generally hollow cylindrical body 22, a disc 24, and a standoff 26, all of which are formed from high strength materials such as metals and/or metal alloys. The body 22 includes a central passage 28 or bore that extends longitudinally. Referring to FIG. 5, the central passage 28 has a first inner diameter located at a first end of the body 22 and a second inner diameter located at a second end of the body 22, with the second inner diameter being greater than the first inner diameter. The first inner diameter is sized to be slightly greater than a diameter of the drill bit 100 with which the drill guide bushing assembly 10 is utilized. The second inner diameter is typically sized to be greater than the first inner diameter by a relative amount, e.g., 10%, 20%, etc., or an absolute amount, e.g., 0.1 inches, 1 millimeter, or the like. The second inner diameter is greater than the first inner diameter in order to provide space for burrs or shavings to exit from the grooves of the drill bit 100. The first inner diameter may extend approximately 50% to approximately 75% of the length of the body 22, while the second inner diameter may extend approximately 25% to approximately 50% of the length of the body 22. In addition, the body 22 includes a groove 30 along a circumference of an outer surface in proximity to the second end.

In some embodiments as shown in the figures, the body 22 has a first outer diameter along a first length extending from the first end, and a second outer diameter along a second length extending from the second end. In other embodiments, the body 22 may have a single outer diameter along the entire length. In general, the first outer diameter and the second outer diameter are each greater than the first inner diameter and the second inner diameter by enough distance to provide sufficient thickness of the body 22 in order to give the drill guide bushing 12 sufficient structural strength.

The disc 24 is attached to the body 22 in the vicinity of the first end and includes an upper surface, a lower surface, and a circumferential or outer surface. The disc 24 also includes a cutout 32 in which the pin 14, described in more detail below, is located. The cutout 32 extends from the upper surface to the lower surface and is positioned along the circumferential surface. The cutout 32 may include three planar orthogonal surfaces, as shown in the figures, with first and second surfaces facing one another and a third surface positioned therebetween. Or, the cutout 32 may include a single, arcuate or partial cylindrical surface. The cutout 32 has dimensions that can accommodate the pin 14. That is, the space between the first and second surfaces and the distance from the third surface to the circumference is greater than a diameter of the pin 14. Alternatively, the diameter of the partial cylindrical surface is greater than the diameter of the pin 14. The outer diameter of the disc 24 is typically greater than the first outer diameter of the body 22 by an amount so that the cutout 32 is positioned to provide sufficient space between the pin 14 and the body 22.

The standoff 26 has a generally cylindrical ring shape with an upper surface, a lower surface, and a circumferential or outer surface. The standoff 26 is attached to the body 22 above the disc 24 so that the lower surface of the standoff 26 is in contact with the upper surface of the disc 24. The standoff 26 has an outer diameter that is greater than the second outer diameter of the body 22 so as to provide a first boundary for the spring 16. The axial length of the standoff 26 may determine, at least in part, the amount of travel for the drill guide bushing 12.

In some embodiments, the components of the drill guide bushing 12 may have a unitary, monolithic, or single piece construction.

The pin 14, also known as a “dowel”, has a generally elongated cylindrical shape and is formed from generally rigid, hardened, and/or high structural strength materials. In some embodiments, the pin 14 may have a threaded outer surface. In other embodiments, the pin 14 may have a quadrilateral or any other polygonal cross-sectional shape.

The spring 16 is of a coil type and has an inner diameter that is greater than the second outer diameter of the body 22. The axial length of the spring 16 may determine, at least in part, the amount of travel for the drill guide bushing 12.

The retaining ring 18 is positioned in the groove 30 of the drill guide bushing 12 and has a generally circular or disc shape. The retaining ring 18 may be formed from resilient materials or flexible materials which allow the retaining ring 18 to be placed in the groove 30 and remain in the groove 30. The retaining ring 18 may also include a locking mechanism which prevents the retaining ring 18 from unintentionally coming out of the groove 30.

The bushing holder 20 includes an upper wall 34, a lower wall 36, and a body 38. The upper wall 34 has a generally hollow cylindrical shape with an upper section and a lower section, wherein the upper wall 34 tapers inwardly from the upper section to the lower section. The upper wall 34 is connected to the body 38 at the lower section. The lower wall 36 also has a generally hollow cylindrical shape with an upper section and a lower section, wherein the lower wall 36 tapers inwardly from the lower section to the upper section. The lower wall 36 is connected to the body 38 at the upper section. The lower wall 36 includes one or more cutouts along the upper section having an arcuate shape. The body 38 has a generally hollow cylindrical shape with a bushing channel 40 having an inner diameter that is slightly larger than the second outer diameter of the drill guide bushing 12. The body 38 includes a recess 42 at a lower end of the bushing channel 40, wherein the recess 42 accommodates the spring 16. The body 38 further includes a cylindrically shaped pin channel 44 extending axially and positioned radially outward from the bushing channel 40. The pin channel 44 retains the pin 14. In some embodiments, the pin channel 44 may be threaded. In the figures, the pin channel 44 is depicted as extending the entire axial length of the body 38. In various embodiments, the pin channel 44 may extend for only a portion of the axial length of the body 38, such that the pin channel 44 is open at one end but closed at the opposite end. The bushing holder 20 typically has a unitary, monolithic, or single piece construction.

In other embodiments, instead of having a single wall with a generally cylindrical shape for the upper wall 34 and the lower wall 36, the bushing holder 20 may include a plurality of upper walls 34 and a plurality of lower walls 36, wherein the upper walls 34 are connected to one another and the lower walls 36 are connected to one another to have a polygonal cross-sectional shape. For example, the bushing holder 20 may include three upper walls 34 connected to one another and three lower walls 36 connected to one another which have a triangular cross-sectional shape. Or, the bushing holder 20 may include four upper walls 34 connected to one another and four lower walls 36 connected to one another which have a quadrilateral cross-sectional shape, and so forth. In addition, the bushing holder 20 need not have the same number of upper walls 34 and lower walls 36. Furthermore, instead of the body 38 of the bushing holder 20 having a single outer surface with a generally cylindrical shape, the body 38 may have a polygonal outer surface with multiple sides.

The drill guide bushing assembly 10 may be assembled as follows, although not necessarily in the order described. The pin 14 is positioned in the pin channel 44 of the bushing holder 20. The length of pin 14 and the depth of the pin channel 44 combine so that a bottom end of the pin 14 is positioned at approximately the lower surface, or just below the lower surface, of the disc 24 of the drill guide bushing 12 when the drill guide bushing assembly 10 is assembled and not in use. The pin 14 is connected to the body 38 of the bushing holder 20 and may be removably positioned in the pin channel 44, fixedly positioned in the pin channel 44, or screwed into the pin channel 44, if the pin 14 and the pin channel 44 are each threaded.

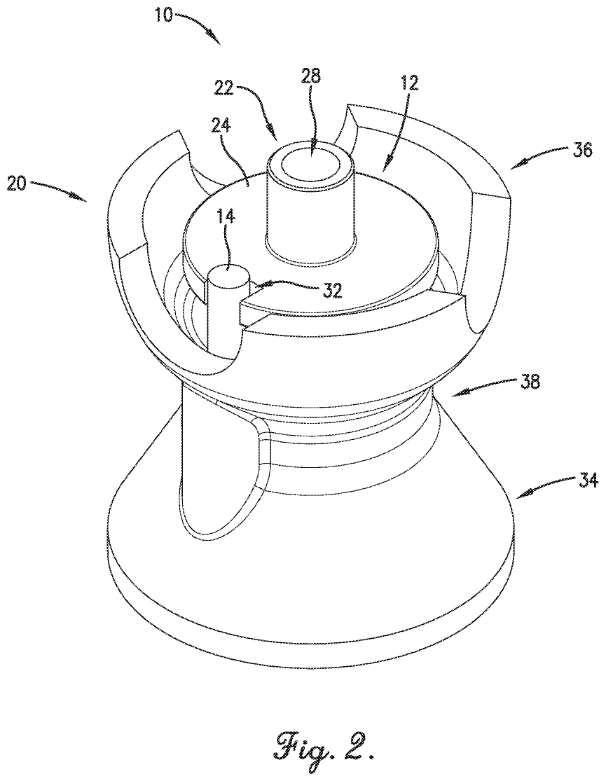

The spring 16 is positioned on the body 22 of the drill guide bushing 12 in contact with the standoff 26, as shown in FIG. 5. The drill guide bushing 12 and the spring 16 are positioned in the bushing channel 40 of the bushing holder 20, such that at least a portion of the spring 16 is positioned in the recess 42. The drill guide bushing 12 is configured to move, or translate, axially within the bushing channel 40. In addition, the drill guide bushing 12 is oriented in the bushing channel 40 such that the pin 14 is positioned in the cutout 32 of the disc 24, as shown in FIGS. 2, 5, and 7-9. Furthermore, when the drill guide bushing assembly 10 is not in use, and the spring 16 is relaxed, the lower end of the drill guide bushing 12 extends below a plane of the lower edge of the lower wall 36 of the bushing holder 20. This allows for the lower end of the drill guide bushing 12 to be easily inserted into the hole 108 before drilling the hole 110.

With the drill guide bushing 12 positioned in the bushing channel 40 of the bushing holder 20, the retaining ring 18 is positioned in the groove 30 of the drill guide bushing 12, as shown in FIG. 1. Any locking mechanism for the retaining ring 18 may be activated. The retaining ring 18 retains the drill guide bushing 12 in the bushing channel 40 of the bushing holder 20.

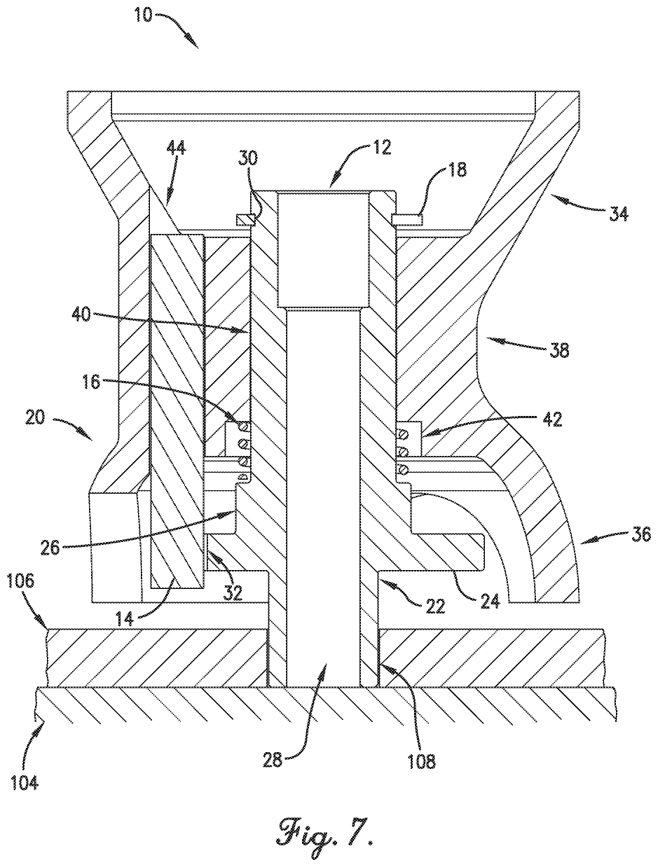

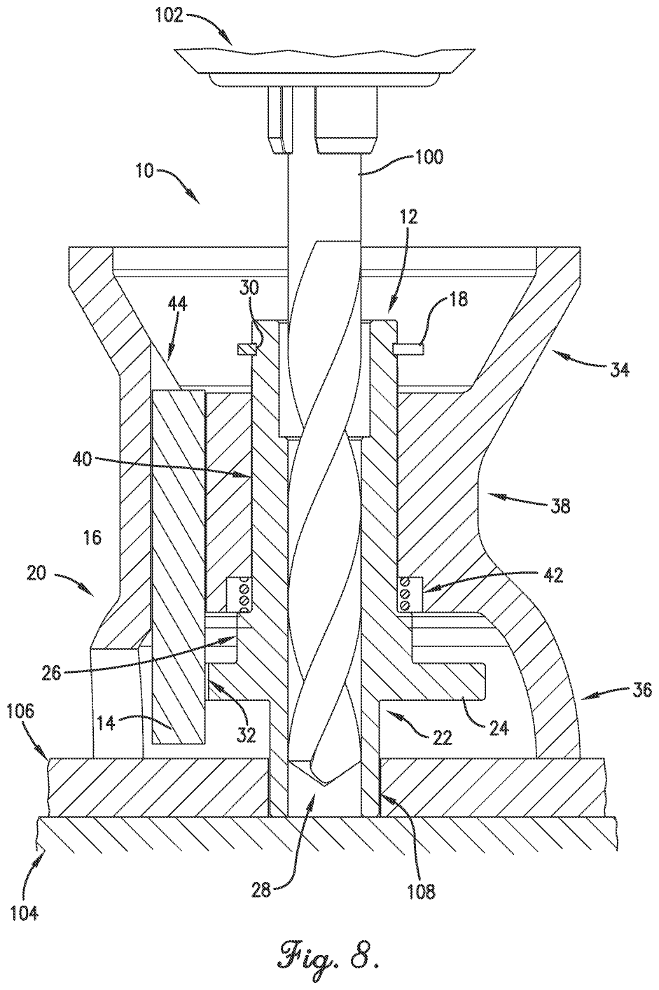

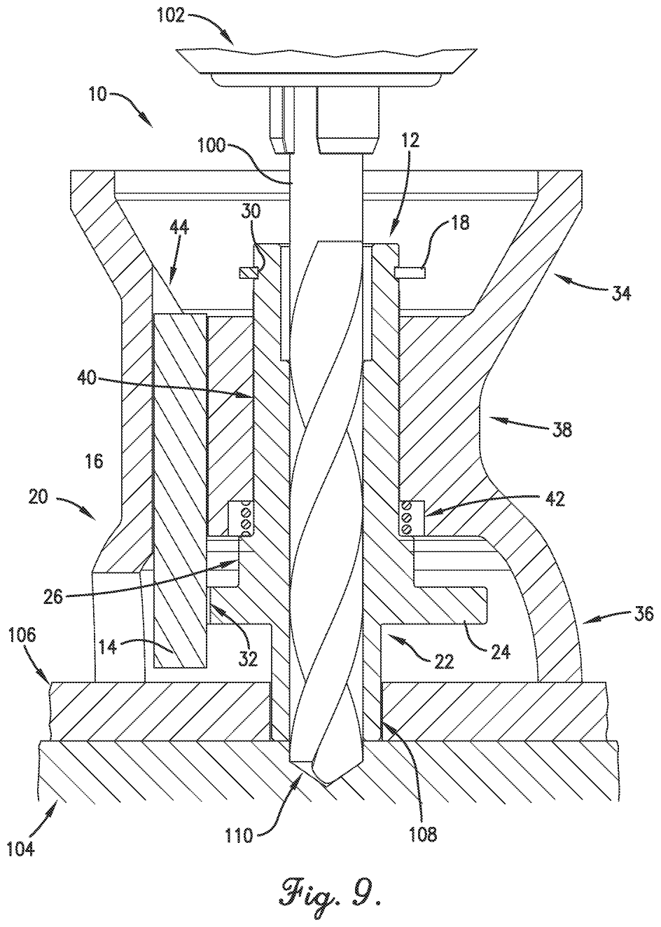

Referring to FIGS. 6-9, in preparation for usage of the drill guide bushing assembly 10, the second object 106 is placed or positioned on top of the first object 104 such that the holes 108 of the second object 106 are aligned with the desired location of holes 110 to be drilled in the first object 104. The drill guide bushing assembly 10 may be utilized as follows, although the order of actions may vary from what is described. Referring to FIG. 7, the drill guide bushing 12 is placed in one of the holes 108 of the second object 106. Referring to FIG. 8, the bushing holder 20 is pressed downward by an operator's hand (not shown), which moves the bushing holder 20 downward with respect to the drill guide bushing 12 and compresses the spring 16. In addition, the downward pressure places the lower edge of the bushing holder 20 into contact with an upper surface of the second object 106, which stabilizes the drill guide bushing assembly 10 on the second object 106. The drill bit 100 is inserted into the central passage 28 of the drill guide bushing 12. The drill 102 is activated and the bit 100 rotates. Referring to FIG. 9, downward pressure is applied to the drill 102 and the bit 100 drills the hole 110 in the first object 104. While drilling the hole 110, burrs or shavings may accumulate in the grooves of the drill bit 100, travel upward, and dislodge into the second diameter of the central passage 28. Given that the drill bit 100 frictionally contacts the wall of the central passage 28 of the drill guide bushing 12 while it is rotating, there is a tendency for the drill guide bushing 12 to rotate as well. However, rotation of the drill guide bushing 12 is prevented by the pin 14 being positioned in the pin channel 44 of the bushing holder 20 and in the cutout 32 of the disc 24 of the drill guide bushing 12.

When drilling of the hole 110 is completed, the drill bit 100 is retracted at least from the hole 110. The operator lifts the bushing holder 20 and removes the drill guide bushing 12 from the hole 108, which decompresses the spring 16 and extends the drill guide bushing 12. If all holes 110 have been drilled, then the operator removes the drill bit 100 from the drill guide bushing 12. If there are more holes 110 to be drilled, then the operator places the drill guide bushing 12 in another one of the holes 108 of the second object 106, and repeats the process described in the previous paragraph. Furthermore, after all of the holes 110 are drilled, each hole 110 may be enlarged by redrilling the hole 110 using a larger diameter drill bit 100, without the use of the drill guide bushing assembly 10.

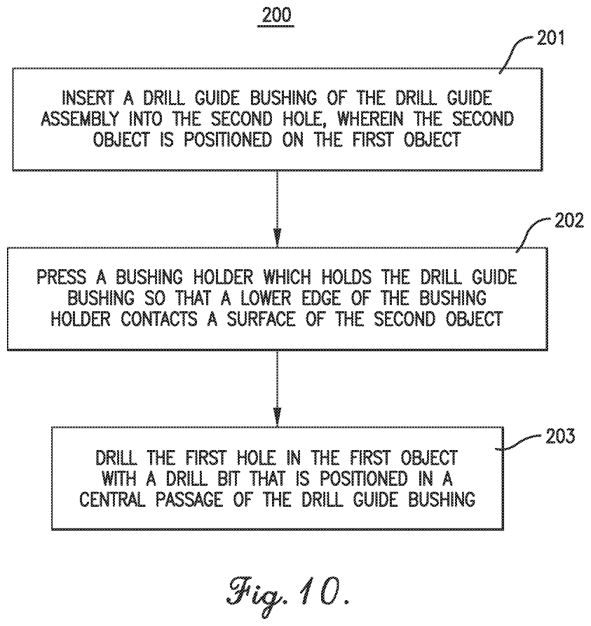

At least a portion of the steps of a method 200 for using a drill guide bushing assembly 10 with a drill 102 and a bit 100 to drill a first hole 110 in a first object 104 using a second hole 108 in a second object 106 for assistance is shown in FIG. 10. The steps may be performed by an operator.

Referring to step 201, a drill guide bushing 12 of the drill guide bushing assembly 10 is inserted into the second hole 108. Referring to FIGS. 6-9, in preparation for usage of the drill guide bushing assembly 10, the second object 106 is placed or positioned on top of the first object 104 such that the holes 108 of the second object 106 are aligned with the desired location of holes 110 to be drilled in the first object 104. Referring to FIG. 7, the drill guide bushing 12 is placed in one of the holes 108 of the second object 106.

Referring to step 202, a bushing holder 20, which holds the drill guide bushing 12, is pressed so that a lower edge of the bushing holder 20 contacts a surface of the second object 106. Referring to FIG. 8, the bushing holder 20 is pressed downward by an operator's hand (not shown), which moves the bushing holder 20 downward with respect to the drill guide bushing 12 and compresses the spring 16. In addition, the downward pressure places the lower edge of the bushing holder 20 into contact with an upper surface of the second object 106, which stabilizes the drill guide bushing assembly 10 on the second object 106.

Referring to step 203, the first hole 110 is drilled in the first object 104 with a drill bit 100 that is positioned in a central passage 28 of the drill guide bushing 12. The drill bit 100 may be inserted in the central passage 28 either before or after the bushing holder 20 is pressed against the second object 106. The drill 102 is activated and the bit 100 rotates. Referring to FIG. 9, downward pressure is applied to the drill 102 and the bit 100 drills the hole 110 in the first object 104. While drilling the hole 110, burrs or shavings may accumulate in the grooves of the drill bit 100, travel upward, and dislodge into the second diameter of the central passage 28. Given that the drill bit 100 frictionally contacts the wall of the central passage 28 of the drill guide bushing 12 while it is rotating, there is a tendency for the drill guide bushing 12 to rotate as well. However, rotation of the drill guide bushing 12 is prevented by the pin 14 being positioned in the pin channel 44 of the bushing holder 20 and in the cutout 32 of the disc 24 of the drill guide bushing 12.

When drilling of the hole 110 is completed, the drill bit 100 is retracted at least from the hole 110. The operator lifts the bushing holder 20 and removes the drill guide bushing 12 from the hole 108, which decompresses the spring 16 and extends the drill guide bushing 12. If all holes 110 have been drilled, then the operator removes the drill bit 100 from the drill guide bushing 12. If there are more holes 110 to be drilled, then the operator places the drill guide bushing 12 in another one of the holes 108 of the second object 106, and repeats the process described in the previous paragraph. Furthermore, after all of the holes 110 are drilled, each hole 110 may be enlarged by redrilling the hole 110 using a larger diameter drill bit 100, without the use of the drill guide bushing assembly 10.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A drill guide bushing assembly for use with a drill and a bit to drill a hole in an object, the drill guide bushing assembly comprising:
a bushing holder including at least one upper wall, at least one lower wall, and a body connected to the at least one upper wall and the at least one lower wall, the body including a bushing channel oriented along the axis thereof and having a hollow cylindrical shape; and
a drill guide bushing including a central passage configured to receive the bit, the drill guide bushing positioned within the bushing channel and configured to move axially therein, the drill guide bushing coupled to the body of the bushing holder such that the drill guide bushing does not rotate within the bushing channel when the hole is being drilled.

2. The drill guide bushing assembly of claim 1, wherein the drill guide bushing includes a disc having a cutout along a circumference thereof, and the drill guide bushing assembly further comprises a pin connected to the body of the bushing holder and positioned in the cutout such that the drill guide bushing is prevented from rotating within the bushing channel.

3. The drill guide bushing assembly of claim 1, further comprising a spring positioned within the bushing channel and around the drill guide bushing, the spring configured to resist axial movement of the drill guide bushing within the bushing channel.

4. The drill guide bushing assembly of claim 1, further comprising a retaining ring coupled to one end of the drill guide bushing, the retaining ring configured to retain the drill guide bushing within the bushing channel.

5. The drill guide bushing assembly of claim 1, wherein the at least one upper wall and the at least one lower wall of the bushing holder each have a cylindrical shape that tapers inward where each wall connects to the body.

6. The drill guide bushing assembly of claim 1, wherein a lower edge of the drill guide bushing extends below a lower edge of the bushing holder.

7. The drill guide bushing assembly of claim 1, wherein the central passage of the drill guide bushing has a first inner diameter that is larger than a diameter of the bit and a second inner diameter that is larger than the first inner diameter.

8. A drill guide bushing assembly for use with a drill and a bit to drill a hole in an object, the drill guide bushing assembly comprising:
a bushing holder including at least one upper wall, at least one lower wall, and a body connected to the at least one upper wall and the at least one lower wall, the body including a bushing channel oriented along the axis thereof and having a hollow cylindrical shape;
a drill guide bushing including a disc having a cutout along a circumference thereof and a central passage configured to receive the bit, the drill guide bushing positioned within the bushing channel and configured to move axially therein; and
a pin connected to the body of the bushing holder and positioned in the cutout such that the drill guide bushing is prevented from rotating within the bushing channel.

9. The drill guide bushing assembly of claim 8, further comprising a spring positioned within the bushing channel and around the drill guide bushing, the spring configured to resist axial movement of the drill guide bushing within the bushing channel.

10. The drill guide bushing assembly of claim 8, further comprising a retaining ring coupled to one end of the drill guide bushing, the retaining ring configured to retain the drill guide bushing within the bushing channel.

11. The drill guide bushing assembly of claim 8, wherein the at least one upper wall and the at least one lower wall of the bushing holder each have a cylindrical shape that tapers inward where each wall connects to the body.

12. The drill guide bushing assembly of claim 8, wherein a lower edge of the drill guide bushing extends below a lower edge of the bushing holder.

13. The drill guide bushing assembly of claim 8, wherein the central passage of the drill guide bushing has a first inner diameter that is larger than a diameter of the bit and a second inner diameter that is larger than the first inner diameter.

14. A method for using a drill guide bushing assembly with a drill and a bit to drill a first hole in a first object using a second hole in a second object for assistance, the method comprising:
inserting a drill guide bushing of the drill guide bushing assembly into the second hole, wherein the second object is positioned on the first object;
pressing a bushing holder, which holds the drill guide bushing, so that a lower edge of the bushing holder contacts a surface of the second object; and
drilling the first hole in the first object with a drill bit that is positioned in a central passage of the drill guide bushing.

15. The method of claim 14, wherein the drill guide bushing assembly includes a pin connected to the bushing holder and the drill guide bushing is coupled to the pin such that the drill guide bushing is prevented from rotating within the bushing channel.

16. The method of claim 14, wherein
the bushing holder includes at least one upper wall, at least one lower wall, and a body connected to the at least one upper wall and the at least one lower wall, the body including a bushing channel oriented along the axis thereof and having a hollow cylindrical shape;
the drill guide bushing includes a disc having a cutout along a circumference thereof, the drill guide bushing positioned within the bushing channel and configured to move axially therein; and
the drill guide bushing assembly further includes a pin connected to the body of the bushing holder and positioned in the cutout such that the drill guide bushing is prevented from rotating within the bushing channel.

17. The method of claim 16, wherein the drill guide bushing assembly further includes a spring positioned within the bushing channel and around the drill guide bushing, the spring configured to resist axial movement of the drill guide bushing within the bushing channel.

18. The method of claim 16, wherein the drill guide bushing assembly further includes a retaining ring coupled to one end of the drill guide bushing, the retaining ring configured to retain the drill guide bushing within the bushing channel.

19. The method of claim 16, wherein the at least one upper wall and the at least one lower wall of the bushing holder each have a cylindrical shape that tapers inward where each wall connects to the body.

20. The method of claim 16, wherein a lower edge of the drill guide bushing extends below a lower edge of the bushing holder.
